(19) United States
(12) Patent Application Publication
(10) Pub. No.: US 2012/0112660 A1
(43) Pub. Date: May 10, 2012

(54) LED Circuit Having LED Driving Circuit with Smooth Transient Mechanism and Operation Method of the Same

(75) Inventor: Kuan-Jen Tseng, Fonghua Village (TW)

(73) Assignee: HIMAX ANALOGIC, INC., Fonghua Village (TW)

(21) Appl. No.: 12/940,129

(22) Filed: Nov. 5, 2010

(51) Int. Cl. H05B 37/02

(52) U.S. Cl. 315/294

(57) ABSTRACT

A LED driving circuit having a smooth transient mechanism adapted in a LED circuit to drive a plurality of LED channels is provided. The LED driving circuit comprises: a dimming module, a dc-to-dc converter, a delay module and a plurality of current sink modules. A control module of the dc-to-dc converter generates a driving voltage according to the dimming voltage from the dimming module to control a gate of a power MOS to further turn on or turn off the LED channels. The delay module comprises delay units connected in series to delay the dimming voltage to generate a plurality of delay signals each at an output node of each of the delay units. Each of the current sink modules is connected to one of the LED channels to adjust the turn-on period according to one of the delay signals. A LED circuit operation method is disclosed herein as well.

### BACKGROUND

1. Technical Field

The present disclosure relates to a LED circuit. More particularly, the present disclosure relates to a LED circuit having a LED driving circuit with a smooth transient mechanism and the operation method of the same.

2. Description of Related Art

LEDs are estimated to be four times as efficient as conventional incandescent lights. They are also claimed to be more economically sound than compact fluorescent bulbs that contain harmful mercury and are supposed to last a lot longer than the conventional lighting. Thus, LEDs may become the mainstream of the lighting technology.

When all the LED channels are turned on at the same time, a large current has to be generated to supply all the LED channels. If there are more and more LED channels presented in the LED circuit, the current becomes larger such that the signal noises and the voltage/current ripples that are undesirable are generated at the output terminal of the driving circuit to drive the LED channels.

Accordingly, what is needed is a LED circuit having a LED driving circuit with a smooth transient mechanism and the operation method of the same to overcome the above issue. The present disclosure addresses such a need.

### SUMMARY

An aspect of the present disclosure is to provide a LED driving circuit having a smooth transient mechanism to drive a plurality of LED channels. The LED driving circuit comprises: a dimming module, a dc-to-dc converter, a delay module and a plurality of current sink modules. The dimming module generates a dimming voltage. The dc-to-dc converter comprises a control module and a power MOS connected to the plurality of LED channels. The control module generates a driving voltage according to the dimming voltage to control the gate of the power MOS to further turn on or turn off the plurality of LED channels. The delay module comprises a plurality of delay units connected in series to delay the dimming voltage to generate a plurality of delay signals each at an output node of each of the delay units, wherein each of the delay units comprises a delay capacitor connected to the output node of the delay unit and a switching module to perform a charge/discharge activity on the delay capacitor according to an input voltage of the delay unit such that the voltage at the output node is delayed by a predetermined cycles from the input voltage to generate one of the delay signals. Each of the plurality of current sink modules is connected to one of the LED channels to adjust the turn-on period of the corresponding LED channel according to one of the delay signals.

Another aspect of the present disclosure is to provide a LED circuit. The LED circuit comprises a plurality of LED channels and a LED driving circuit. The LED driving circuit comprises: a dimming module, a dc-to-dc converter, a delay module and a plurality of current sink modules. The dimming module generates a dimming voltage. The dc-to-dc converter comprises a control module and a power MOS connected to the plurality of LED channels. The control module generates a driving voltage according to the dimming voltage to control the gate of the power MOS to further turn on or turn off the plurality of LED channels. The delay module comprises a plurality of delay units connected in series to delay the dimming voltage to generate a plurality of delay signals each at an output node of each of the delay units, wherein each of the delay units comprises a delay capacitor connected to the output node of the delay unit and a switching module to perform a charge/discharge activity on the delay capacitor according to an input voltage of the delay unit such that the voltage at the output node is delayed by a predetermined cycles from the input voltage to generate one of the delay signals. Each of the plurality of current sink modules is connected to one of the LED channels to adjust the turn-on period of the corresponding LED channel according to one of the delay signals.

Yet another aspect of the present disclosure is to provide a LED circuit operation method. The LED circuit operation method comprises the steps as follows. A dimming voltage is generated. A driving voltage is generated according to the dimming voltage to control the gate of the power MOS to turn on or turn off the plurality of LED channels. A plurality of delay signals each at an output node of one of a plurality of delay units connected in series in a delay module are generated by delaying the dimming voltage, wherein each of the delay units comprises a delay capacitor connected to the output node and a switching module, the step of generating the plurality of delay signals further comprises the steps as follows. An input voltage is received to the switching module. The switching module performs a charge/discharge activity on the delay capacitor according to the input voltage. A voltage at the output node that is delayed by a predetermined cycles from the input voltage is generated to generate one of the delay signals. The turn-on period of the LED channels is adjusted according to the delay signals.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a diagram of a LED circuit of an embodiment of the present disclosure;

FIG. 2 is a further detailed diagram of the LED channels, the delay module and the current sink modules depicted in FIG. 1;

FIG. 3 is a diagram of the delay units in the delay module;

FIG. 4 is a diagram of the waveforms of the dimming voltage Vdm, the delay signals D1, D2 and D3;

FIG. 5 is a diagram of the current sink module;

FIG. 6 is a diagram of the delay units in another embodiment of the present disclosure; and

FIG. 7 is a flow chart of a LED circuit operation method of an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

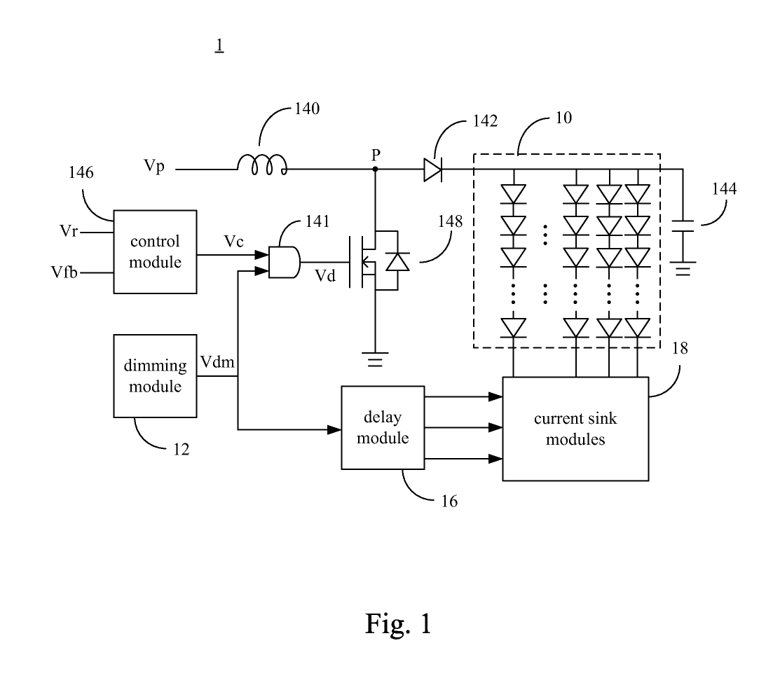

Please refer to FIG. 1. FIG. 1 is a diagram of a LED circuit 1 of an embodiment of the present disclosure. The LED circuit 1 comprises a plurality of LED channels 10 and a LED driving circuit. The LED driving circuit comprises a dimming module 12, a dc-to-dc converter, a delay module 16 and a plurality of current sink modules 18 (depicted as one block).

The dc-to-dc converter comprises an inductor 140, a diode 142, a capacitor 144, a control module 146 and a power MOS 148.

The inductor 140 couples a supply voltage Vp to a first node P. The diode 142 is connected between the first node P and the LED channels 10, wherein the anode of the diode 142 is connected to the first node P, and the cathode of the diode 14 is connected to the capacitor 144. The capacitor 144 is connected to the LED channels 10. It's noticed that the number of the LED channels 10 and the number of LED in each channel can be different in various embodiments.

In an embodiment, the control module 146 may comprise an error amplifier and a pulse width modulator (not shown). The error amplifier generates a comparison result according to a reference voltage Vr and a feedback voltage Vfb related to the LED channels 10. The pulse width modulator further generates a control voltage Vc according to the comparison result and an oscillating signal. The control voltage Vc in an embodiment is a square wave. In the present embodiment, the control module 146 further comprises a AND gate 141 to receive the control voltage Vc.

The dimming module 12 is able to generate a dimming voltage Vdm. The AND gate 141 described above further receives the dimming voltage Vdm to generate a driving voltage Vd to the gate of the power MOS 148, so that only when both the control voltage Vc and the dimming voltage Vdm is at a high state, the driving voltage Vd turns high to turn on the power MOS 148 and when one of the control voltage Vc and the dimming voltage Vdm is at a low state, the driving voltage Vd turns low to turn off the power MOS 148. The power MOS 148 thus is operative to be turned on and off to charge or discharge the capacitor 144 so that the LED channels 10 turn on and off according to the charging and discharging activities of the capacitor 144. Each of the current sink modules 18 is connected to one of the LED channels 10 to provide a stabilization mechanism.

However, when the number of the LED channels 10 increases, the current needed to drive the whole LED channels 10 at the same time increases as well. The large current may cause signal noises and the voltage/current ripples that are undesirable at the first node P.

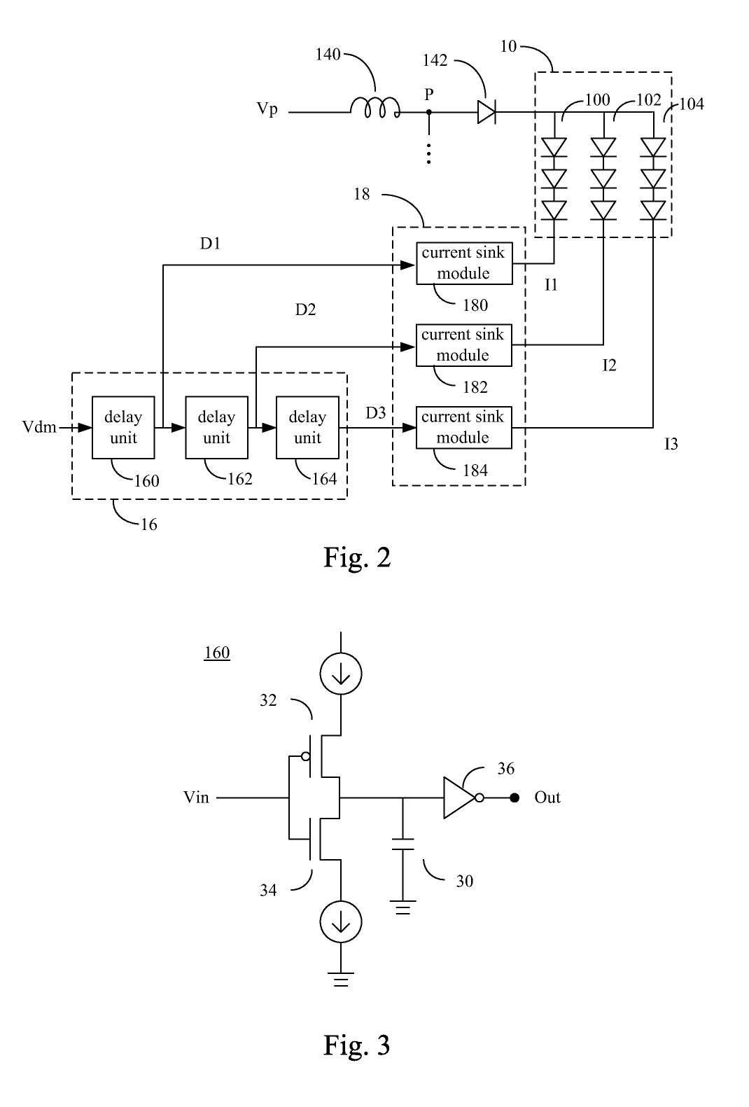

Thus, the delay module 16 in the present embodiment provides a smooth transient mechanism. Please refer to FIG. 2. FIG. 2 is a diagram of the LED channels 10, the delay module 16 and the current sink modules 18.

In order to give a clear explanation, the group of LED channels 10 having three LED channels 100, 102 and 104 are used as an example in the present embodiment. In other embodiments, the number of the LED channels 10 and the number of LED in each channel can be different. Thus, the delay module 16 comprises three delay units 160, 162 and 164 connected in series and the current sink modules 18 comprises three current sink modules 180, 182 and 184. The current sink modules 180, 182 and 184 are connected to the LED channels 100, 102 and 104 respectively. It's noticed that the dimming module 12, the AND gate 141, the control module 146 and the power MOS 148 are omitted and not shown in FIG. 2. However, the delay module 16 is substantially connected to the dimming module 12 as depicted in FIG. 1.

Please refer to FIG. 3 at the same time. FIG. 3 is a diagram of the delay units 160. The delay unit 160 comprises a delay capacitor 30 connected to an output node Out of the delay unit 160, a switching module and an inverter 36. The switching module in the present embodiment comprises a high side PMOS 32 and a low side NMOS 34. The gates of the high side PMOS 32 and the low side NMOS 34 are to receive an input voltage Vin. The input voltage Vin for the delay unit 160, which is the first delay unit in the delay module 16, is the dimming voltage Vdm. The input voltages Vin of the delay units 162 and 164 other than the first delay unit 160 are from the previous delay unit. In other words, the input voltage Vin of the delay unit 162 is received form the output node of the delay unit 160, i.e. the output voltage of the delay unit 160, and the input voltage Vin of the delay unit 164 is received form the output node of the delay unit 162, i.e. the output voltage of the delay unit 162.

Upon receiving the input voltage Vin, which is the dimming voltage Vdm for the delay unit 160, the gates of the high side PMOS 32 and the low side NMOS 34 begin to charge or discharge the delay capacitor 30. In the present embodiment, when the dimming voltage Vdm goes low, the high side PMOS 32 turns on to gradually charges the delay capacitor 30. After a specific time period, the delay capacitor 30 reaches a high level. The inverter 36 connected between the delay capacitor 30 and the output node Out thus makes the voltage at the output node Out turns low. However, due to the time it takes to charge the delay capacitor 30, the voltage at the output node Out has a predetermined cycles of delay as compared to the dimming voltage Vdm.

Similarly, when the dimming voltage Vdm goes high, the low side NMOS 34 turns on to gradually discharges the delay capacitor 30. After a specific time period, the delay capacitor 30 reaches a low level such that the inverter 36 makes the voltage at the output node Out turns high. Due to the series connection form of the delay units 160, 162 and 164 in the delay module 16, the delay signals D1, D2 and D3 generated from the delay units 160, 162 and 164 respectively have an increasing amount phase shift with respect to the dimming voltage Vdm.

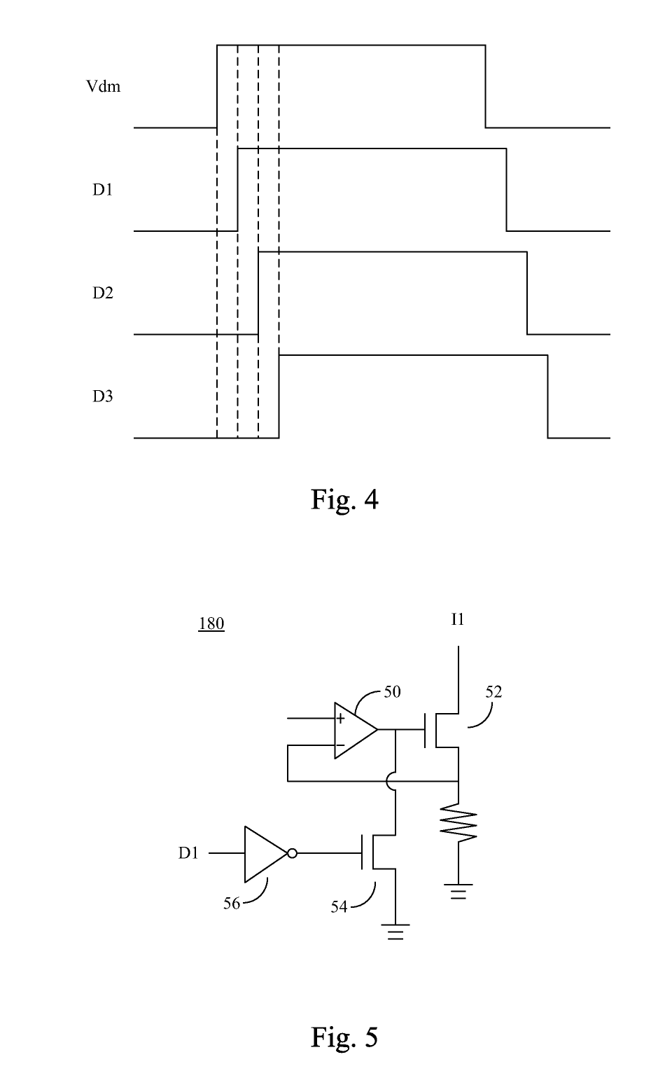

Please refer to FIG. 4. FIG. 4 is a diagram of the waveforms of the dimming voltage Vdm, the delay signals D1, D2 and D3. It can be shown that the delay signals D1, D2 and D3 are each delayed by a specific interval due to the operation of the switching module and the delay capacitor.

Please refer to FIG. 5. FIG. 5 is a diagram of the current sink module 180. The current sink module 180 comprises an operational amplifier 50, a switch 52 and a switch 54. The switch 52 receives the current I1 from the LED channel 100 when the LED channel 100 turns on. The operational amplifier 50 controls the gate of the switch 52 to stabilize the current I1. The switch 54 is connected to the gate of the switch 52 as well. The switch 54 further receives the delay signal D1 from the delay unit 160. When the delay signal D1 is at a low voltage level, the inverter 56 that receives the delay signal D1 further turns on the switch 54 to pull low the voltage at the gate of the switch 52 to make the switch 52 turns off. Therefore, the current sink module 180 is disabled to forbid the turn-on of the LED channel 100. When the delay signal D1 is at a high voltage level, the inverter 56 further turns off the switch 54 so that the switch 52 turns on to make the LED channel 100 operates.

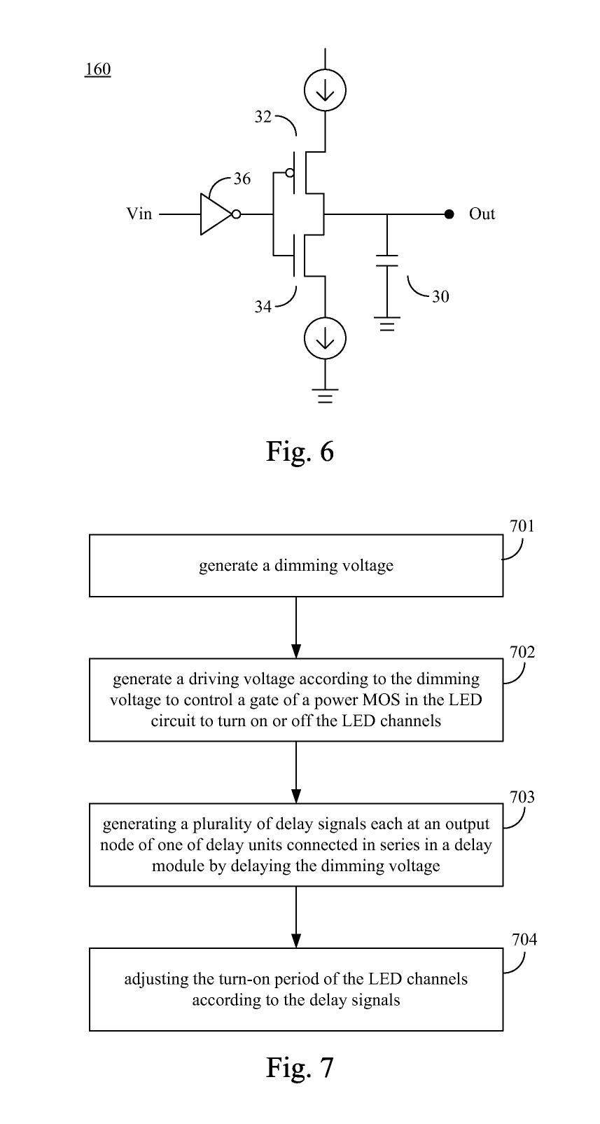

Accordingly, when the driving voltage Vd triggers the power MOS 148 depicted in FIG. 1 to turn on the LED channels 10 according to the dimming voltage Vdm, the LED channels 100, 102 and 104 turns on one by one according to the delay signals D1, D2 and D3. The current supplied to the LED channels 10 increases gradually instead of enormously. The effect of the noise and the ripples can be suppressed. It's noticed that the delay signals D1, D2 and D3 overlap as depicted in FIG. 4 such that the LED channels 100, 102 and 104 can turn on one by one immediately to make the waveform of the current supplied to the LED channels becomes a smooth and continuous curve. Please refer to FIG. 6. FIG. 6 is a diagram of the delay units 160 in another embodiment of the present disclosure. In the present embodiment, the inverter 36 is disposed to receive the input voltage Vin to further control the gate of the high side PMOS 32 and the low side NMOS 34. Therefore, when the dimming voltage Vdm goes low, the inverter 36 makes the low side NMOS 34 turn on to gradually discharges the delay capacitor 30. After a specific time period, the delay capacitor 30 reaches a low level and the output node Out thus makes the voltage at the output node Out turns low as well. On the contrary, when the dimming voltage Vdm goes high, the inverter 36 makes the high side PMOS 32 turn on to gradually charges the delay capacitor 30. After a specific time period, the delay capacitor 30 reaches a high level and the output node Out thus makes the voltage at the output node Out turns high as well. The delay units 160 depicted in FIG. 6 can accomplish the same operation result as the delay units 160 depicted in FIG. 3.

Please refer to FIG. 7. FIG. 7 is a flow chart of a LED circuit operation method of an embodiment of the present disclosure. The LED circuit operation method can be adapted in the LED circuit 1 depicted in FIG. 1. The LED circuit operation method comprises the steps as follows. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 701, the dimming voltage Vdm is generated from the dimming module 12. A driving voltage Vd is generated by the control module 146 according to the dimming voltage Vdm to control the gate of the power MOS 148 to turn on or turn off the plurality of LED channels 10 in step 702.

In step 703, a plurality of delay signals D1, D2 and D3 each at an output node of one of a plurality of delay units 160, 162 and 164 connected in series in a delay module 16 are generated by delaying the dimming voltage Vdm. The step of generating the plurality of delay signals D1, D2 and D3 further comprises receiving an input voltage Vin to the switching module of the delay unit 160, 162 or 164, performing a charge/discharge activity on the delay capacitor 30 according to the input voltage Vin and delaying the voltage at the output node Out by a predetermined cycles from the input voltage Vin to generate one of the delay signals D1, D2 or D3. In step 704, the turn-on period of the LED channels 10 is adjusted according to the delay signals D1, D2 and D3.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A LED driving circuit having a smooth transient mechanism to drive a plurality of LED channels, wherein the LED driving circuit comprises:
a dimming module to generate a dimming voltage;
a dc-to-dc converter comprising a control module and a power MOS connected to the plurality of LED channels, wherein the control module is to generate a driving voltage according to the dimming voltage to control a gate of the power MOS to further turn on or turn off the plurality of LED channels;
a delay module comprising a plurality of delay units connected in series to delay the dimming voltage to generate a plurality of delay signals each at an output node of each of the delay units, wherein each of the delay units comprises a delay capacitor connected to the output node of the delay unit and a switching module to perform a charge/discharge activity on the delay capacitor according to an input voltage of the delay unit such that the voltage at the output node is delayed by a predetermined cycles from the input voltage to generate one of the delay signals; and
a plurality of current sink modules each connected to one of the LED channels to adjust the turn-on period of the corresponding LED channel according to one of the delay signals.

2. The LED driving circuit of claim 1, wherein the delay signals overlap.

3. The LED driving circuit of claim 1, wherein the dc-to-dc converter further comprises:
an inductor coupled a supply voltage to a first node;
a diode connected between the first node and the LED channels; and
a capacitor connected to the LED channels, wherein the power MOS is substantially connected to the first node to charge or discharge the capacitor according to the driving voltage.

4. The LED driving circuit of claim 3, wherein an anode of the diode is connected to the first node, and a cathode of the diode is connected to the capacitor.

5. The LED driving circuit of claim 1, wherein when one of the delay signals is at a high voltage level, the corresponding current sink module is enabled to allow the turn-on of the corresponding LED channel, and when the one of the delay signals is at a low voltage level, the corresponding current sink module is disabled to forbid the turn-on of the corresponding LED channel.

6. The LED driving circuit of claim 1, wherein the switching module comprises a high side PMOS and a low side NMOS, wherein gates of the high side PMOS and the low side NMOS are to receive the input voltage, the delay capacitor is substantially connected to the output node through an inverter.

7. The LED driving circuit of claim 1, wherein the switching module comprises a high side PMOS and a low side NMOS, wherein gates of the high side PMOS and the low side NMOS are connected to an inverter such that the inverter receives the input voltage.

8. The LED driving circuit of claim 1, wherein the plurality of delay units comprises a first delay unit, wherein the input voltage of the first delay unit is the dimming voltage and the input voltage of each the delay units other than the first delay unit is from a previous delay unit.

9. A LED circuit, comprising:
a plurality of LED channels; and
a LED driving circuit comprising:
a dimming module to generate a dimming voltage;
a dc-to-dc converter comprising a control module and a power MOS connected to the plurality of LED channels, wherein the control module is to generate a driving voltage according to the dimming voltage to control a gate of the power MOS to further turn on or turn off the plurality of LED channels;
a delay module comprising a plurality of delay units connected in series to delay the dimming voltage to generate a plurality of delay signals each at an output node of each of the delay units, wherein each of the delay units comprises a delay capacitor connected to the output node of the delay unit and a switching module to perform a charge/discharge activity on the delay capacitor according to an input voltage of the delay unit such that the voltage at the output node is delayed by a predetermined cycles from the input voltage to generate one of the delay signals; and
a plurality of current sink modules each connected to one of the LED channels to adjust the turn-on period of the corresponding LED channel according to one of the delay signals.

10. The LED circuit of claim 9, wherein the delay signals overlap.

11. The LED circuit of claim 9, wherein the dc-to-dc converter further comprises:
an inductor coupled a supply voltage to a first node;
a diode connected between the first node and the LED channels; and
a capacitor connected to the LED channels, wherein the power MOS is substantially connected to the first node to charge or discharge the capacitor according to the driving voltage.

12. The LED circuit of claim 11, wherein an anode of the diode is connected to the first node, and a cathode of the diode is connected to the capacitor.

13. The LED circuit of claim 9, wherein when one of the delay signals is at a high voltage level, the corresponding current sink module is enabled to allow the turn-on of the corresponding LED channel, and when the one of the delay signals is at a low voltage level, the corresponding current sink module is disabled to forbid the turn-on of the corresponding LED channel.

14. The LED circuit of claim 9, wherein the switching module comprises a high side PMOS and a low side NMOS, wherein gates of the high side PMOS and the low side NMOS are to receive the input voltage, the delay capacitor is substantially connected to the output node through an inverter.

15. The LED circuit of claim 9, wherein the switching module comprises a high side PMOS and a low side NMOS, wherein gates of the high side PMOS and the low side NMOS are connected to an inverter such that the inverter receives the input voltage.

16. The LED circuit of claim 9, wherein the plurality of delay units comprises a first delay unit, wherein the input voltage of the first delay unit is the dimming voltage and the input voltage of each the delay units other than the first delay unit is from a previous delay unit.

17. A LED circuit operation method comprising the steps of:
generate a dimming voltage;
generate a driving voltage according to the dimming voltage to control a gate of a power MOS in the LED circuit to turn on or turn off the plurality of LED channels;
generating a plurality of delay signals each at an output node of one of a plurality of delay units connected in series in a delay module by delaying the dimming voltage, wherein each of the delay units comprises a delay capacitor connected to the output node and a switching module, the step of generating the plurality of delay signals further comprises:
receiving an input voltage to the switching module;
making the switching module perform a charge/discharge activity on the delay capacitor according to the input voltage; and
generating a voltage at the output node that is delayed by a predetermined cycles from the input voltage to generate one of the delay signals; and
adjusting the turn-on period of the LED channels according to the delay signals.

18. The LED operation method of claim 17, wherein the delay signals overlap.

19. The LED operation method of claim 17, wherein when one of the delay signals is at a high voltage level, a current sink module adapted to the corresponding LED channel is enabled to allow the turn-on of the corresponding LED channel, and when the one of the delay signals is at a low voltage level, the current sink module adapted to the corresponding LED channel is disabled to forbid the turn-on of the corresponding LED channel.
